(19) United States
(12) Patent Application Publication
(10) Pub. No.: US 2017/0339754 A1
(43) Pub. Date: Nov. 23, 2017

(54) MICROWAVE DISH WITH HEAT PEDESTAL

(71) Applicant: George Manos, Oceanside, CA (US)

(72) Inventor: George Manos, Oceanside, CA (US)

(21) Appl. No.: 15/599,391

(22) Filed: May 18, 2017

Related U.S. Application Data
(60) Provisional application No. 62/339,379, filed on May 20, 2016.

(51) Int. Cl. H05B 6/64

(52) U.S. Cl. CPC H05B 6/6408

(57) ABSTRACT

An apparatus for microwave heating is disclosed, comprising a heating appliance capable of providing thermal heat to material within the appliance. A pedestal within a middle portion of the heating appliance is capable of providing further thermal heat to the material, which may comprise food or liquid, or other microwavable material.

### CROSS-REFERENCE TO RELATED APPLICATIONS

This Application claims the benefit of U.S. Provisional Patent Application No. 62/339,379, entitled “Microwaveable Boat That Will Perfectly Cook Scrambled Eggs To Be Used For Omelettes And Other Egg Entrees, Single Serving Muffins, Pancakes Bakery Products All Within 2 Minutes”, filed May 20, 2016, the contents of which are incorporated herein by reference in their entirety.

### FIELD OF THE INVENTION

Disclosed and described is a microwave dish with one or more heat pedestals. Specifically, a heat pedestal is attached, or is attachable, to a microwave dish that formed to maximize surface heating surface area.

### BACKGROUND OF THE INVENTION

A microwave oven is an appliance that uses electromagnetic energy to heat and cook foods. A microwave uses microwaves, very short radio waves commonly employed in radar and satellite communications. When concentrated within a small space, these waves efficiently heat water and other substances within foods.

Microwaves cook food rapidly and efficiently because, unlike conventional ovens, they heat only the food and not the air or the oven walls. The heat spreads within food by conduction.

Microwaves pass through many types of glass, paper, ceramics, and plastics, making many containers composed of these materials good for holding food. Various types of microwavable dishes are currently available in the marketplace. One drawback to these types of dishes is that they do not cause the food to heat evenly. When the material of the dish heats up along with the food, it may spread through the dish and add thermal energy or heat to the food that the wall of the dish touches. However, the middle of the food away from the dish walls will not receive as much thermal energy.

U.S. Pat. No. 4,143,647 to Husslein et al describes a microwavable dish wherein a portion of the dish which surrounds the food is formed from a material having high-frequency radiation absorption characteristics. This enables the area surrounding the food to be heated by the high-frequency radiation to such an extent that there is no, or only a small, thermal gradient between the heated food and the dish material which prevents the food from rapidly cooling down. However, this does not solve the challenge of heating the food more evenly, including from the middle portion of the food to be heated.

U.S. Pat. No. 5,052,369 to Johnson teaches a heat retaining food container having a cover and a bottom portion, wherein each one of the cover and bottom portion includes a heat storage system comprised of a non-metallic heat storing mass enclosed within a sealed chamber. The walls forming the chamber are formed from a polymeric material which is transparent to microwave radiation, heat stable up to approximately 400° F., chemically stable to detergents and rinsing agents, and resistant to staining. The container may be safely heated in a conventional oven or a microwave. A dish holding hot food may be placed within the heated food container in order to keep the food warm. However, Johnson similarly fails to solve the challenge of heating the food more evenly, including from the middle portion of the food to be heated.

None of the above patents describes a suitable system that solves the challenge of heating the food at specific points, including in the middle portion of the food to be heated. Further, none of the above patents, taken either singularly or in combination, is seen to describe the instant invention as claimed. Thus, a system and method that heats food more evenly, including from the middle portion of the food to be heated, is desired.

### SUMMARY OF THE INVENTION

In order to solve the problems and shortcomings of the prior art, an apparatus is disclosed for dispensing items. According to one preferred embodiment, an apparatus for microwave heating, comprising a heating appliance capable of providing thermal heat to material within the appliance; and a pedestal within a middle portion of the heating appliance that is capable of providing further thermal heat to the material.

According to another preferred embodiment, an apparatus for microwave heating, comprises a heating appliance capable of providing thermal heat to material within the appliance; and a removable pedestal within a middle portion of the heating appliance that is capable of providing further thermal heat to the material.

### BRIEF DESCRIPTION OF THE DRAWINGS

These and other features, aspects, and advantages of the present invention will become better understood with reference to the following description, appended claims, and accompanying drawings where:

FIG. 1 is a front-top perspective view of the described apparatus according to one embodiment;

FIG. 2 is a front elevational view of the embodiment of FIG. 1, with the pedestal shown in phantom;

FIG. 3 is a side cross-sectional view of the bowl and pedestal according to one embodiment;

FIG. 4 is a bottom perspective view of the bowl according to the embodiment of FIG. 3;

FIG. 5 is a cross-sectional view of another embodiment that includes multiple detachable pedestals; and

FIG. 6 is a top elevational view of the embodiment of FIG. 5, with the pedestals removed from the base attachments.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

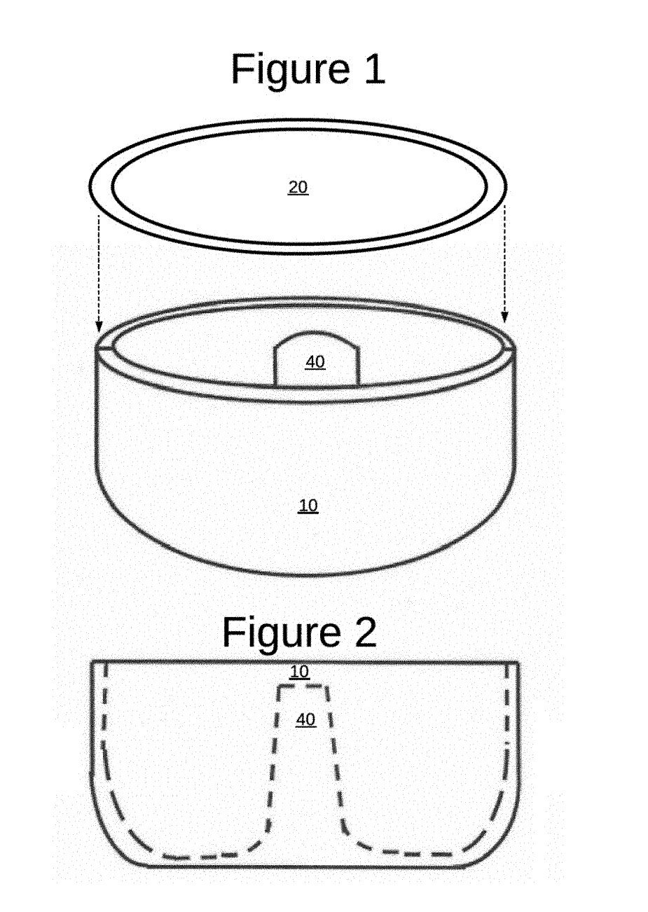

The microwave oven dish in accordance with preferred embodiments of the present invention is illustrated in FIGS. 1-6, wherein like reference numerals are used throughout to designate like elements.

With reference to FIG. 1, according to one embodiment, an apparatus, dish or bowl 10 for heating food, liquid, or other items, in a microwave oven is shown. In one embodiment, a pedestal 40 is fixed in a mid-portion of the bowl 10 provides further surface area of the dish for more consistent heating. Just as the source surrounding the food provides for thermal heating from the heating of the bowl material, the pedestal 40 further provides for thermal heating of the food.

With reference to FIG. 2, a front elevational view of the embodiment of FIG. 1, with the pedestal 40 shown in phantom, is illustrated. In one embodiment, the inside portion of the bowl 10, and the pedestal 40, may form a sinuous inside curved cross section in order to maximize surface area between the bowl material and the food, to thus further increase even heating from the bowl material.

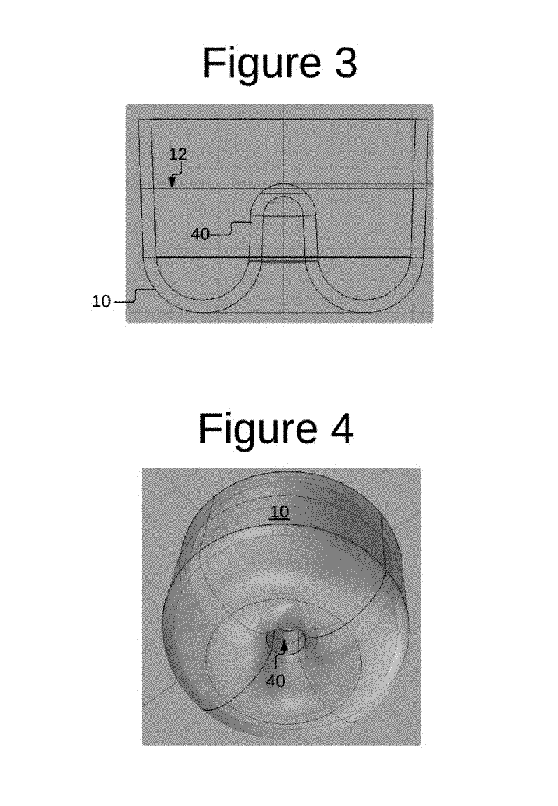

With reference to FIG. 3, a side cross-sectional view of the bowl 10 and pedestal 40 according to one embodiment, is shown. In the embodiment of FIG. 3, the pedestal may have a height that is lower than the embodiment of FIGS. 1 and 3. A fill line 12 may be provided to guide the user to fill the bowl 10 with food or liquid to a height that maximizes heating from the pedestal 40 and inner surface of the bowl 10.

With reference to FIG. 4, a bottom perspective view of the bowl 10 is shown according to the embodiment of FIG. 3. As shown in both FIGS. 3 and 4, in one embodiment, the bowl 10 and pedestal 40 may be formed by wall of material of relatively consistent thickness to provide for a more evenly distributed thermal heating layer throughout the outside wall of the bowl 10, bottom portion of the bowl 10, and pedestal 40. It can be seen in FIG. 4, looking up from the bottom from the bowl 10, the pedestal 40 may be formed by a continued hollow indentation from the bottom of the bowl to provide for a consistent thickness in the material forming the bowl 10 and the pedestal 40. With reference back to FIG. 1, a removable lid 20 may be included, which may be made out of the same material and at the same thickness for the same reasons of providing thermal uniformity with respect to the walls of the bowl 10 and the pedestal.

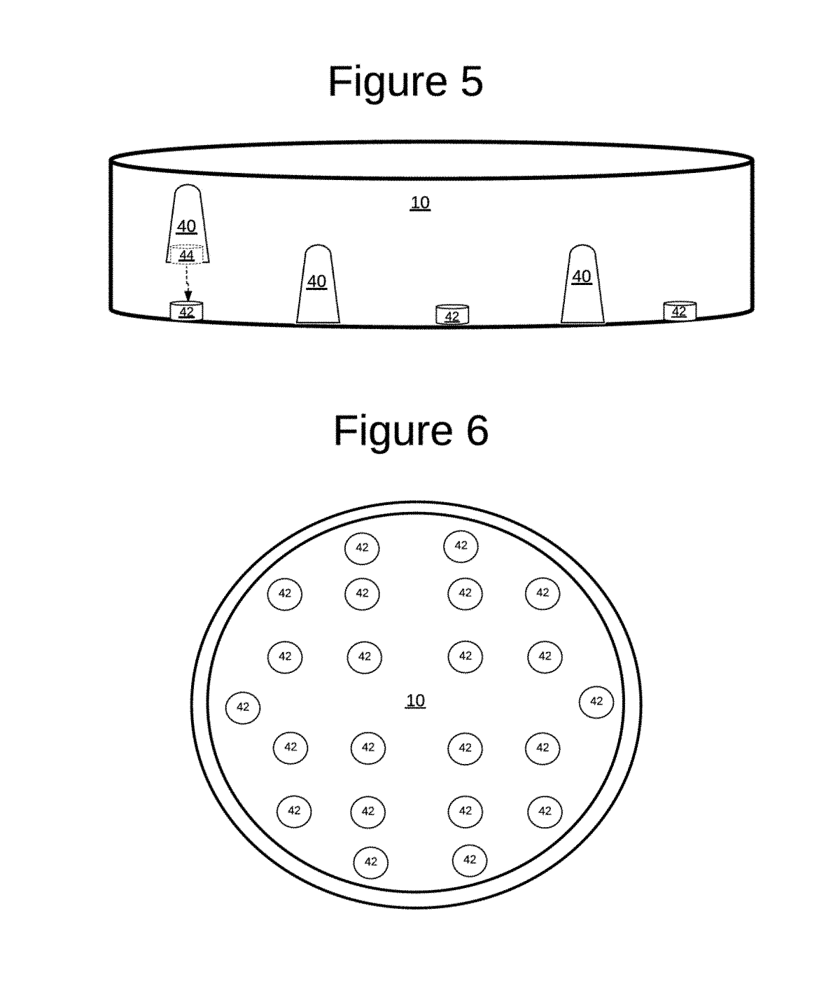

With reference to FIG. 5, a cross sectional view of another embodiment that includes multiple detachable pedestals 40 is shown. Larger dishes that are cooked in the microwave are particularly amenable to uneven heating. Larger pots, dishes, or bowls 10 may benefit from multiple pedestals 40. Still, sometimes, less pedestals 40, or no pedestals 40 at all, may be desirable for heating certain foods and liquids. Thus, in the embodiment of FIG. 5, several pedestal base attachments 42 may be included on the bottom of the bowl 10. By way of example, and not by way of limitation, each base attachment 42 may comprise a male member that may fit or attach into a female receptacle 44 of each detachable pedestal 40. Other attachment means may be used that would be contemplated by those of skill in the art. For example, a hook and twist system may be used to attach each pedestal 40 to each base attachment 42.

FIG. 6 is a top elevational view of the embodiment of FIG. 5, with the pedestals 40 removed from the base attachments 42. The base attachments 42 may be evenly or unevenly distributed. The user has flexibility with regard to the distribution of pedestals 40 throughout the bowl 10 with this configuration of base attachments 42.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. An apparatus for microwave heating, comprising:
a heating appliance capable of providing thermal heat to material within the appliance; and
a pedestal within a middle portion of the heating appliance that is capable of providing further thermal heat to the material.

2. The apparatus of claim 1, wherein the material is food.

3. The apparatus of claim 1, wherein the material is liquid.

4. The apparatus of claim 1, comprising a rounded curve that is continuous between an inner surface of the heating appliance and the pedestal to provide a maximal thermal surface area to the food with the pedestal.

5. The apparatus of claim 1, wherein the apparatus is a bowl.

6. The apparatus of claim 1, wherein the apparatus is a pot.

7. An apparatus for microwave heating, comprising:
a heating appliance capable of providing thermal heat to material within the appliance; and
a removable pedestal within a middle portion of the heating appliance that is capable of providing further thermal heat to the material.

8. The apparatus of claim 7, wherein the material is food.

9. The apparatus of claim 7, wherein the material is liquid.

10. The apparatus of claim 7, comprising a base attachment capable of attaching the removable pedestal within the apparatus.

11. The apparatus of claim 10, comprising a plurality of base attachments, each capable of attaching one or more removable pedestals.

12. The apparatus of claim 11, wherein each pedestal comprises a corresponding attaching portion that fits each base attachment.
